(19) United States
(12) Patent Application Publication
(10) Pub. No.: US 2026/0254228 A1
(43) Pub. Date: Aug. 27, 2026

(54) RECTIFIER WITH INRUSH PROTECTION BYPASS PASSING CURRENT IN ONE DIRECTION ONLY AND METHOD FOR STARTING UP POWER SUPPLY TO A RECTIFIER

(71) Applicant: Danfoss Power Electronics A/S, Grästen (DK)

(72) Inventor: Jimmy Larsen, Gråsten (DK)

(21) Appl. No.: 19/463,811

(22) Filed: Jan. 29, 2026

(30) Foreign Application Priority Data
Feb. 5, 2025 (DE) 102025104172.5

(51) Int. Cl. H02H 7/125; H02M 1/12; H02M 7/217

(52) U.S. Cl. CPC H02H 7/125; H02M 1/126; H02M 7/217

(57) ABSTRACT

The disclosure relates to a rectifier (1) for rectifying alternating current from a power source (80) with N phases (PA, PB, PC), wherein N is at least two. It includes a power input (2) for connection with the power source (80), an LCL filter (30) connected to the power input (2) via an interruption unit (40), an active front end (10) with at least two levels that includes a direct current bus (11) and is connected to the power input (2) via the LCL filter (30) and the interruption unit (40). The interruption unit (40) is switchable to an interrupting state in which it disconnects the LCL filter (30) and hence the active front end (10) from the power input (2) for N-1 phases (PA, PB), said N-1 phases (PA, PB) including a first phase (PA). The rectifier (1) has an inrush protection bypass (50) for bypassing the interruption unit (40) for the first phase (PA). In order to provide reliable and cheap protection from excessive inrush currents for the rectifier (1) while allowing for particularly high efficiency of the rectifier (1) in normal operation, the inrush protection bypass (50) is conductive only for current flow in one specific direction.

### CROSS-REFERENCE TO RELATED APPLICATIONS

This application claims foreign priority benefits under 35 U.S.C. § 119 to German Patent Application No. 102025104172.5 filed on Feb. 5, 2025, the content of which is hereby incorporated by reference in its entirety.

### TECHNICAL FIELD

The present invention relates to a rectifier for rectifying alternating current from a power source with N phases, wherein N is at least two, and a method for starting up power supply to such a rectifier.

### BACKGROUND

Rectifiers for rectifying alternating current (AC) from a power source with N phases are frequently used in various different devices, e.g. in power supplies for electric motors or to provide direct current for industry applications. In many applications, the power source has three phases (N=3). Alternating current is usually present in public power grids, for example with a grid frequency of 50 Hz in Europe and 60 Hz in the United States of America. The rectifier transforms alternating current into direct current. The rectifier may be used for various purposes, for example for driving electronic circuitry (which typically operate with direct current), for charging batteries/accumulators, or as a so-to-say intermediate direct current that is to be converted back to an alternating electric current with a different frequency (typically using so-called inverters).

The rectifier typically comprises a power input for connection with the power source and an LCL filter connected to the power input. A modern rectifier can further comprise an active front end that includes a direct current bus (DC bus) with two bus lines as output of the rectifier. The active front end is connected to the power input via the LCL filter. The LCL filter can remove elevated frequency perturbations that otherwise could be imposed on the power source, e.g. an alternating current power grid (AC grid). Such elevated frequency perturbations can, for example, arise from influences of a common mode in the active front end.

A switch arrangement of the active front end as such typically cannot yet generate a smooth, steady DC voltage. Usually, the switch arrangement as such can only generate a DC voltage with significant ripples. Hence, some kind of a smoothening of the output DC voltage has to be performed for most use cases.

To smooth the DC voltage, various possibilities exist in the prior art. However, at least to a certain extent, they (essentially) all use comparatively large sized capacitors for smoothing.

Typically, the bus lines of the active front end are coupled via smoothing capacitors. The smoothing capacitors reduce fluctuations in a direct current power output of the DC bus. For example, the reduce the DC voltage ripples. Accordingly, the smoothing capacitors hence should have substantial capacities.

Further, the LCL filter includes, for each of the phases, at least two inductivities. Between said two inductivities, the LCL filter connects the respective phase via at least one capacitor to the common mode in the LCL filter.

The common mode in the LCL filter can be also connected to the common mode in the active front end.

It is also known that the rectifier can include an interruption unit. The interruption unit can be used to turn off of the rectifier while the power input remains connected to the power supply. The interruption is switchable to an interrupting state in which it disconnects the LCL filter- and hence the active front end-from the power input for at least N-1 phases, e.g. for at least two of three phases. Accordingly, no currents can flow between the power input and the power source on the one hand and the LCL filter and the active front end on the other hand. The interruption unit can include switches for interrupting at least the N-1 phases.

In normal operation of the rectifier (in order to supply direct current output power), the interruption unit is switched to a connecting state. All the switches of the interruption unit are closed (i.e. they are electrically conductive). In the connecting state, the LCL filter and hence the active front end are connected with the power input for all phases. The LCL filter can reduce the imposing of undesired harmonics on the power supply. This can help to ensure conformity with regulatory restrictions.

Hence, for bringing the rectifier from a non-operational condition, in which the interruption unit is in the interrupting state, to the normal operation, at some point in time the switches of the interruption unit must be closed. At this point in time, excessive currents can flow between the active front end and the LCL filter on the one hand and the power input at the other hand. The excessive currents result mainly from a pre-charging of the smoothing capacitors in the active front end. Further, the charging of the capacitors in the LCL filter contributes to the excessive currents when the power supply to the rectifier is started up. Those excessive currents may be referred to as “inrush currents”.

The inrush currents decrease with increasing pre-charging (“saturation”) of the relevant capacitors. Nevertheless, until then, the excessive inrush currents can cause various problems. For example, the inrush currents might trip fuses, which is certainly not a desired behaviour. Further, the inrush can impose undesired load peaks on the grid.

The maximum allowed adverse influences on the grid is usually regulated by the operator of the grid and has usually comparatively tight limits, which generally require the use of some inrush current limiting methods.

The excessive inrush currents can damage components of the rectifier directly. For example, they can overload rectifying devices, for example diodes in the active front end. Further, the excessive inrush currents can generate undesired heat and hence warm up components to high temperatures, which might also result in damages.

A large variety of inrush electric circuit protection devices has already been proposed in the prior art.

One obvious design for an inrush current protection would be to implement a simple ohmic resistor directly the existing circuit, for example respectively directly in the connections between the LCL and the power input. Even a comparatively small ohmic resistor might efficiently will reduce an excessive inrush current. However, in such an arrangement, the ohmic resistances of said ohmic resistors are also added in the normal operation of the rectifier. This impairs the efficiency. Further, a considerable thermal warming of the ohmic resistors can occur. This thermal warming can lead to a destruction of the ohmic resistors and/or may even cause of a fire.

To reduce the negative effects of simple ohmic resistors, the use of negative temperature coefficient resistors (NTC resistors) instead of the simple ohmic resistors has been proposed. The idea is that during starting up the power supply to the rectifier, the NTC resistors are still cold and show a comparatively high electric resistance, thus significantly reducing the inrush current. Over time, the NTC resistors heat up. As a consequence, their electric resistance decreases when the rectifier has been switched on for some time, preferably when no inrush current is present anymore. The NTC resistors “fade out” (at least to some extent) after they have limited the amount of the inrush current. Nevertheless, a residual electric resistance of each NTC resistor remains. This still causes a reduction of efficiency of the rectifier in normal operation and there may be still problems with significant thermal heating of the NTC resistors.

### SUMMARY

The problem underlying the invention to provide reliable and cheap protection from excessive inrush currents for a rectifier (for rectifying alternating current with at least two phases) while allowing for particularly high efficiency of the rectifier in normal operation.

This problem is solved by a rectifier with the features according to claim 1.

The rectifier is for rectifying alternating current from a power source with N phases, wherein N is at least two.

The rectifier comprises:
a power input for connection with the power source;
an LCL filter connected to the power input via an interruption unit;
an active front end with at least two levels, wherein the active front end includes a direct current bus with bus lines and is connected to the power input via the LCL filter and the interruption unit; the interruption unit, wherein the interruption unit is switchable to an interrupting state in which the interruption unit disconnects the LCL filter and hence the active front end from the power input for N-1 phases of the N phases, said N-1 phases including a first phase; and an inrush protection bypass for bypassing the interruption unit (at least) for the first phase, wherein the inrush protection bypass is conductive only for current flow in one specific direction.

The proposed solution provides reliable and cheap protection from excessive inrush currents. The proposed solution is simple and cost-efficient.

The inrush protection forwards only currents flowing in the specific direction. These currents can be used for pre-charging smoothing capacitors in the active front end and capacitors in the LCL filter when starting up the power supply to the rectifier.

The inrush protection bypass blocks currents that would flow in an opposite direction (which is opposite to the specific direction) from passing through the inrush protection bypass.

In other words, the inrush protection bypass includes a half-wave rectification functionality for the inrush current(s). The current flow through the inrush protection bypass is practically halved.

A “residual” phase is the one phase of the N phases that is not within said N-1 phases that is disconnected by the interruption unit in the interrupting state of the latter.

The current flowing between the first phase and the residual phase through the bypass protection unit in the interrupted state may be referred to as first pre-charging current.

In the interrupting state, only one of positive half waves and negative half waves of an AC current that could theoretically flow between the first phase and the residual phase can pass through the inrush protection bypass and is used as the (actual) first pre-charging current. The other one of the positive half waves and the negative half waves of the AC current that could theoretically flow between the first phase and the residual phase is blocked from passing through the inrush protection bypass.

In other words, the first pre-charging current occurring during the startup of the power supply is half-wave rectified by the inrush protection bypass. An average of an absolute vale of the first pre-charging current is thus substantially lower compared to a hypothetical case in which the inrush protection bypass would not block the first pre-charging current from flowing in the opposite direction.

Accordingly, the inrush current is substantially decreased. Less extensive load peaks will be imposed on the power supply during starting up the power supply to the rectifier. The risk of undesired heating and damages of components due to excessive inrush currents is considerably reduced.

With the disclosed approach, reactive current flow in the LCL filter (from phase to phase) is blocked. Capacitors in the LCL filter are pre-charged to a DC voltage only. This reduces the pre-charging current(s) through the inrush protection bypass and brings a reactive power consumption down.

In general, it is noted that the relevant capacitors are prevented from partial “de-charging” which might happen if the first pre-charging current in the opposite direction was not blocked. This beneficial for the efficiency of the recharging and might also reduce the stress on the relevant capacitors.

The half-wave rectification of the first pre-charging current by the inrush protection bypass can also improve the electromagnetic compatibility of the rectifier during starting up the power supply to the latter.

In a normal operation, no current needs to pass through the inrush protection bypass.

All currents can normally flow through the interruption unit (in its connecting state). In the normal operation of the rectifier, the inrush protection bypass hence neither impairs the efficiency of the rectifier nor causes thermal problems.

According to one aspect, the first phase can be any one of said N-1 phases. The term “first phase” does not include any additional implications (e.g. regarding relative geometric positions, relative phase shifts, etc.).

According to one aspect, the inrush protection bypass includes at least one bypass branch (e.g. for the first phase).

The at least one bypass branch can be with unidirectionality means. The unidirectionality means blocks current flows in a direction opposite to the specific direction.

In one embodiment, the unidirectionality means include a diode. Especially, the unidirectionality means can consist of a diode. Further, the unidirectionality means include (also encompassing the case of consisting of) several diodes that are connected in parallel. A diode typically does not introduce a significant ohmic resistance.

Additionally or alternatively, the at least one bypass branch further includes a resistor means that is arranged in series with the unidirectionality means. The resistor means further reduce the first pre-charging current. This reduces the risk of excessive inrush currents further.

Since the half-wave rectification functionality of the inrush protection bypass also reduces the average absolute current that is flowing through the at least one bypass branch during starting up of the rectifier, the half-wave rectification functionality also protects the resistor means, e.g. from being overloaded and/or from excessive heating up. the half-wave rectification functionality blocks reactive current flow caused by the LCL filter through the resistor means. A risk of failure of the resistor means is reduced by the half-wave rectification functionality of the inrush protection bypass. Less demanding requirements apply for the resistor means. The resistor means can be smaller and cheaper.

Vice versa, the resistor means can help to limit the current flow through the unidirectionality means, e.g. the diode(s), if applicable. This can allow for using cheap standard elements for the unidirectionality means, e.g. one or more cheap standard diodes.

The resistor means can include at least one resistor. The resistor means can include several (i.e. at least two) resistors. Some or all of these resistors may be connected in parallel (to distribute the first pre-charging current). Some or all of these resistors may be connected in series (to decrease voltage drops over the individual resistors. Some or all of the resistors may be of the same type. Some or all of the resistors may be of different types.

Optionally, the resistor means may be configured such that an electric resistance of the resistor means increases with a temperature of at least one element of the resistor means and/or that an electric resistance of the resistor means increases with increasing current through the resistor means. This exhibits some automatic self-protection of the inrush protection bypass against excessive (inrush) currents.

According to one aspect, the resistor means may include a positive thermal coefficient resistor (a PTC resistor). An electric resistance of the PTC resistor at high temperatures is larger than at low temperatures. When the first pre-charging current is excessive, the PTC resistor will heat up to high temperatures and it will reduce the first pre-charging current stronger. This improves the protection against excessive inrush currents. However, when the first pre-charging current is low, the PTC resistor will not heat up or heat up less and its electrical resistance will be lower. This is beneficial for good efficiency as long as the first pre-charging current is not excessive. In other words, using a PTC resistor in the inrush protection circuit allows for a self-adjusting protection mechanism against inrush currents becoming excessive. Naturally, the resistor means can include several PTC resistors.

The implementation of PTC resistors is also advantageous for cases in which repeated (re-)starting of the rectifier occurs. For example, this can occur when power failures of the power supply occur repeatedly in short time. Elements of the rectifier, including the resistor means of the inrush protection bypass, will be subject to repeated starting up of the power supply and hence to repeated inrush currents. The elements may not have enough time to cool down between subsequent new start-ups of the power supply. The PTC resistor(s) provide automatic self-protection for such cases.

Additionally or alternatively, the resistor means can include an ohmic resistor. Ohmic resistors are comparatively cheap and easy to implement. The resistor means may include several ohmic resistors.

In one embodiment, the at least one bypass branch includes a fuse. The fuse provides additional protection against excessive inrush currents.

According to one aspect, the bus lines can be coupled via smoothing capacitors, wherein the rectifier is configured for pre-charging the smoothing capacitors with the inrush protection bypass by a pre-charging current flowing with respect to the first phase (above referred to as the first pre-charging current) when the interruption unit is in the interrupting state, wherein the inrush protection bypass allows only passage of positive half waves or negative half waves for the (first) pre-charging current. This facilitates implementing particularly controlled and efficient pre-charging of the smoothing capacitors.

The inrush proception bypass can include (at least) two bypass branches, e.g. for the first phase, in parallel. By this, the (first) pre-charging current can be distributed onto several bypass branches. Accordingly, the parts of the pre-charging currents flowing through the elements (such as diodes and/or PTC resistors) in the individual bypass branches can be reduced.

In one embodiment, the rectifier further includes a line filter, wherein the line filter is functionally arranged between the power input and the interruption unit. In other words, the interruption unit (and hence the LCL filter and the active front end) may be connected to the power input via the line filter. The line filter may include (especially consist of) a radio frequence interference filter (RFI filter). The line filter may help that less harmonics/high frequencies will be imposed by the rectifier to the power supply. Such harmonics can be, for example, result from the switching of semiconductor switches in the active front end. The line filter can help to fulfill regulatory requirements.

According to one aspect, the rectifier includes can include a first connection pathway for connecting the active front end with the first phase of the power supply.

A supply-side end of the inrush protection bypass can be connected (electrically “attached”) between the interruption unit and the power input, maybe more specifically between the interruption unit and the line filter (if applicable). Especially, the supply side end of the bypass branch(es) for the first phase may be connected to the first connection pathway between the interruption unit and the LCL filter, maybe more specifically between the interruption unit and the line filter (if applicable).

A front-end-side of the inrush protection bypass might be connected (electrically “attached”) between the interruption unit and the LCL filter. Especially, the front end side of the bypass branch(es) for the first phase may be connected to the first connection pathway between the interruption unit and the LCL filter. The LCL filter provides some protection for the inrush protection bypass against influences imposed by the active front end. This implementation can help to reduce stresses in the case of surges. For example, it may happen that one or more switches of the interruption unit opens during a surge. Hence, the bypass branch(es) for the respective phase(s) must bear the surge. The LCL filter includes impedances in series. Those impedances in-between the active front end and the front-end-side end of the inrush protection bypass may mitigate the effects of surges. Apart from that, less or no component stress will arise in the inrush protection bypass from repetitive peak voltages at the DC bus. Furthermore, compared to the situation described below (according to which the front-end side of the inrush protection bypass can be connected to one of the bus lines), there is no short circuit of the LCL filter via the inrush protection bypass which could result in the emission of high frequency noise towards the power supply. Still further, in normal operation, the inrush protection bypass is fully protected by the adjacent closed switches of the interruption unit in normal operation (despite of the active front end being active or inactive). Finally, the inrush protection bypass is “in-line” with power paths and does not require additional connections (e.g. cables) to the DC bus.

Especially, the inrush protection bypass may only bypass the interruption unit for the relevant phase(s), e.g. at least for the first phase.

Additionally or alternatively, the at least one bypass branch for one of the N-1 phases (e.g. for the first phase) can be connected in parallel to a branch of the interruption unit for the same phase.

In one embodiment, the front-end-side of the inrush protection bypass is (alternatively or alternatively) connected to one of the bus lines. Hence, the inrush current for pre-charging the smoothing capacitors can at least partly (for example, at least between the first phase and the active front end) bypass the LCL filter. This implementation offers the same advantage of avoiding the reactive current flow.

The rectifier may comprise a controller for switching the interruption unit between the interrupting state and the connecting state. This allows automated control of the interruption unit. For example, the rectifier can be configured for performing a start-up sequence. In a first stage of the start-up sequence, the controller controls the interruption unit to be in the interrupting state. In a second phase, the controller controls the interruption unit to switch to the connecting state.

In general, it is not necessary that all of the open interruption devices are closed at the same time in the course of the start-up sequence. For example, the controller may control the initially open interruption devices to close at different times in the second phase. However, the rectifier can be configured such that all open interruption devices are closed at least substantially at the same time in the course of the start-up sequence.

The controller may control the interruption unit to be in (maintain) the connecting state during normal operation of the rectifier. Hence, no currents (at least no substantial currents) will flow through the inrush protection bypass in normal operation. This protects the inrush protection bypass and its components in normal operation.

The inrush currents, especially the pre-charging current(s) flowing through the inrush protection bypass will be typically particularly high at the beginning of the first stage of the start-up sequence and then decrease gradually. One the one hand, due to the half-wave rectification functionality of the inrush protection bypass, the first stage of the start-up sequence may need to be longer compared to a case without the half-wave rectification functionality. It may take more time to reach a same degree of pre-charging in the capacitors. However, typically, the start-up sequence is normally performed only very rarely and still short in absolute terms. Thus, the prolonged first phase is not a severe drawback. On the other hand, the inrush currents are reduced with the disclosed approach and the components of the rectifier are protected better against damages during the start-up sequence. Further, the blocking of the reactive currents from the LCL filter during the first phase by the half-wave rectification functionality of the inrush protection bypass results in better energetic efficiency in the first phase. By varying the number of bypass branches and/or an effective electric resistance of the resistor means, the time that is necessary to reach a desired pre-charging of the relevant capacitors (especially the smoothing capacitors at the DC bus and/or the capacitors of the LCL filter) can be adjusted. Accordingly, a time duration of the first phase can be adapted.

The rectifier may be configured such that changing from the first phase to the second stage of the start-up sequence, especially controller operating the interruption unit from the interrupting state to the connecting state, is based (at least) on one of, several, or all of the following:
a time delay;
at least one measured voltage (e.g. a DC bus voltage, a voltage drop over one or more of the smoothing capacitors, and/or a voltage drop over one or more of the capacitors in the LCL filter, a voltage drop over at least one element of the resistor means, etc.);
at least on a measured current (e.g. at least one current through the inrush protection bypass);
at least one measured temperature (e.g. at least one temperature of the rectifier, a temperature of at least one element in the resistor means, etc.); and
at least one electrical charge count.

The rectifier may include the needed sensors. The sensors may be connected with the controller.

According to one aspect, the interruption unit can include, for each of the N-1 phases, respectively at least one interruption device. Each interruption device can be switchable between an open state and a closed state. In the interrupting state, all interruption devices for the N-1 phases may be in the open state. In the connecting state, all interruption devices of the interruption unit may in the closed state.

In general, when referring to an open state/a closed state of the switching device, this does not necessarily mean an (essentially) ideal open or closed state. Depending on the individual type of the switching device, a somewhat high electric resistance may relate to the open state, while a somewhat high electric conductivity may relate to the closed state of the switching device. According to one aspect, in its closed sate, the electric resistance of the switching device is far lower than an electric resistance of the inrush protection bypass in the specific direction for the same phase, e.g. less than a thousandth at the maximum or even a tenth at the maximum.

Additionally or alternatively, in its open state, the electric conductivity of the switching device is lower than an electric conductivity of the inrush protection bypass in the specific direction for the same phase, e.g. a fiftieth at the maximum or even a thousandth at the maximum, for example virtually zero.

Especially, one of, several of, or all of the interruption devices can be electric relays. An electric relay is suitable for high currents. It is reliable. It provides a particularly proper closed state (e.g. with no significant electrical resistance) and a particularly proper open state (e.g. with no conductivity and high breakthrough voltage).

In the individual electric relay, an actuator of the electric relay may be particularly a magnetic coil/magnetic armature combination.

Additionally or alternatively, the individual switching device can include any one of, several of, or all of the following (non-limiting) examples:
a thyristor;
an Insulated-gate Bipolar Transistor (IGBT),
a field effect transistor;
a motor-actuated switch.

If the individual switching device includes only one thyristor, IGBT, or field effect transistor, a corresponding body-diode can be added (e.g. an intrinsic body diode and/or a discrete body diode). Naturally, the individual switching device can also include two antiparallel thyristors, IGBTs, and/or field effect transistors.

Optionally, the interruption unit may be also switchable to a disconnecting state in which the interruption unit disconnects the LCL filter and hence the active front end from the power input for the N phases (including also the residual phase).

In other words, the interruption unit may include, respectively for each of the N phases, at least one switching device.

In the disconnecting state, the smoothening capacitors of the active front end and/or the capacitors may be prevented from pre-charging. On the one hand, such a disconnecting state can be advantageous under some circumstances in view of safety considerations. On the other hand, in this implementation, at least one switch, e.g. at least one (power) relay is necessary for each phase. Since power relays with the required current carrying capabilities are expensive, it can be advantageous if the interruption unit is free of switches, especially free of (power) relays, for the residual phase.

When the disconnecting state applies, the start-up sequence may include that the controller controls the interruption unit to switch from the disconnecting state to the interrupting state for starting the first phase.

In general, it is sufficient if the inrush protection bypass is configured for bypassing the interruption unit for at least one of the N-1 phases, in the text referred to as the first phase for the sake of nomenclature. Experiments have shown that this is sufficient for proper pre-charging of the relevant capacitors. It saves costs and reduces complexity if the inrush protection bypass is configured for bypassing the interruption unit for art exactly one of the N-1 phases, which may be referred to as the first phase as above. Furthermore, in this case, the current through the first phase (with the bypassing) and the residual phase will be at least substantially the same.

According to one aspect, N (i.e. the number of phases) is at least three, wherein the inrush protection bypass may be for bypassing the interruption unit for several of the N-1 phases, wherein the inrush protection bypass is conductive for current flow in the one specific direction for the several of the N-1 phases.

In this specific context, “several of the N-1 phases” means “at least two of the N-1 phases” and encompasses the case “all of the N-1 phases”.

The half-wave rectification functionality works towards the one and same direction for all of this several of the N-1 phases.

As cited above, the N-1 phases are all of the N phases except the residual phase.

With the inrush protection bypass bypassing the interruption unit for the several of the N-1 phases, a total pre-charging current flowing through the residual phase on the one hand can be distributed to flow through the several of the N-phases on the other hand. This can be used to decrease the individual pre-charging currents in said several of the N-1 phases. This means less stress for those phases and the corresponding individual parts of the inrush protection bypass. Additionally or alternatively, the approach can be used to increase a total pre-charging current (corresponding to the combination of the individual pre-charging currents), at least as long as the current through the residual phase does not become too high. This can be used to reduce the duration of the start-up sequence.

For each of the several of the N-1 phases, the inrush protection bypass can be implemented according to any one of the embodiments and modification as described with respect to the first phase. The implementation of the inrush protection bypass can be the same for some or all of said several of the N-1 phases.

For example, the inrush protection bypass may be for bypassing the interruption unit for the first phase and for a second phase of the N-1 phases, wherein the inrush protection bypass is conductive only for current flow in the one specific direction for the first phase and second phase.

According to one aspect, the second phase can be any other one (than the first phase) of said N-1 phases. The term “second phase” does not include any additional implications (e.g. regarding relative geometric positions, relative phase shifts, etc.). The terms “first phase” and “second phase” do not include any additional implication regarding these two phases (e.g. regarding a geometrical order, a ranking, relative phase shifts, etc.).

In one embodiment, the inrush protection bypass is for bypassing the interruption unit for all of the N-1 phases (i.e. for all of the N-phases except the residual phase), wherein the inrush protection bypass is conductive only for current flow in the one specific direction for all of the N-1 phases.

According to one aspect, the inrush protection bypass does not bypass the residual phase (which in the interrupting state connects the LCL with the power input anyway). It is possible that the inrush protection bypass is not directly electrically connected with the residual phase. In other words, it is not directly electrically attached to the residual phase. The residual phase may be free from any direct electrical connections with the inrush protection electrically bypassing parts of the connection between the LCL filter and the power input for the residual phase.

In one embodiment, the active front end includes semiconductor switches that are operable with switching frequencies of at least 2 kHz, maybe at least 25 kHz. Additionally or alternatively, the semiconductor switches are operable with switching frequencies that correspond to at least 40 times a grid frequency, maybe to at least 500 times of the grid frequency. This allows for efficient normal operation.

The semiconductor switches can be connected to the controller and the controller can be configured to control the operation of the semiconductor switches.

The rectifier can form part of a larger assembly, e.g. of motor drive for an electric motor, an AC-DC-AC converter, an DC-AC-DC converter, and/or the like.

The problem mentioned above is further solved by a method with the features according to claim 15.

It is a method for starting up power supply to a rectifier, wherein the rectifier is for rectifying alternating current from a power source with N phases, wherein N is at least two, and comprises a power input, an LCL filter connected to the power input via an interruption unit, and an active front end with at least two levels, wherein the active front end includes a direct current bus with bus lines and is connected to the power input via the LCL filter and the interruption unit,

The method includes:
Providing alternating current from the power source to the power input while the interruption unit is switched to an interrupting state in which the interruption unit disconnects the LCL filter and hence the active front end from the power input for N-1 phases of the N phases, said N-1 phases including a first phase;
pre-charging at least smoothing capacitors that couple the bus lines using (at least) a first pre-charging current flowing through the first phase, wherein an inrush protection bypass bypasses the first pre-charging current past the interruption for the first phase in the interruption unit and (half-wave-)rectifies the first pre-charging current in a specific direction.

Any one of the features, embodiments, modifications, and advantages described regarding the rectifier may apply accordingly to the method, and vice versa.

The first pre-charging current flows also through the residual phase.

According to one aspect, the method includes switching the interruption unit to a connecting state such that the LCL filter and hence the active front end are connected to the power supply for all N phases for normal operation of the rectifier. For example, this the controller explained above might operate the interruption unit accordingly, e.g. in the second stage of the start-up sequence.

Optionally, the method includes pre-charging at least the smoothing capacitors using several pre-charging currents, each one flowing through another one of the N-1 phases, wherein the inrush protection bypass bypasses the pre-charging currents past the interruption for the corresponding phase in the interruption unit and (half-wave-)rectifies the several pre-charging current in the same specific direction.

For example, the said N-1 phases may include second phase (different from the first phase), and the method may include: pre-charging at least the smoothing capacitors that couple the bus lines using (at least) a first pre-charging current flowing through the first phase and a second pre-charging current flowing through the second phase, wherein the inrush protection bypass bypasses the first pre-charging current past the interruption for the first phase in the interruption unit and bypasses the second pre-charging current past the interruption for the second phase in the interruption unit, and wherein the inrush protection bypass (half-wave-)rectifies the first pre-charging current and the second pre-charging current in the same specific direction.

Additional features, advantages and possible applications of the invention result from the following description of exemplary embodiments and the drawings. All the features described and/or illustrated graphically here form the subject matter of the invention, either alone or in any desired combination, regardless of how they are combined in the claims or in their references back to preceding claims.

### BRIEF DESCRIPTION OF THE DRAWINGS

Preferred embodiments of the invention will now be described with reference to the drawings, in which:

FIG. 1 schematically shows a first embodiment of a rectifier according to the present invention with an inrush protection bypass for a first phase, wherein the inrush protection bypass includes a half-wave rectification functionality;

FIG. 2A schematically shows a modification of the rectifier of FIG. 1 during a positive half-wave of a first pre-charging current flowing through the first phase and the inrush protection bypass and a residual phase, wherein this modification is not in accordance with the present invention;

FIG. 2B schematically shows the modified rectifier of FIG. 2A during a negative half-wave of the first pre-charging current flowing through the first phase and the inrush protection bypass and the residual phase;

FIG. 3 schematically shows a second embodiment of a rectifier according to the present invention, in which a front-end-side end of the inrush protection bypass is connected to a bus line of a direct current bus of an active front end of the rectifier;

FIG. 4 shows a first modification of the inrush protection bypass of the rectifier of FIG. 1; and

FIG. 5 shows a second modification of the inrush protection bypass of the rectifier of FIG. 1.

### DETAILED DESCRIPTION

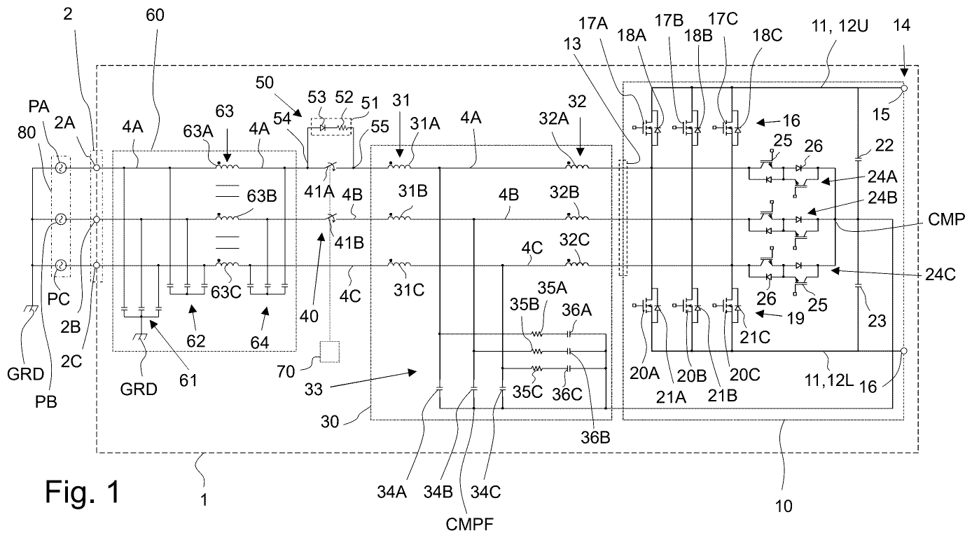

FIG. 1 shows a first embodiment of a rectifier 1. The rectifier includes a power input 2. The power input 2 is connected to a power supply 80. It provides electric power in the form of alternating current (AC) with three phases PA, PB, PC. A number N of phases is hence three. For the sake of nomenclature, the three phases may be referred to as a first phase PA, a second phase PB, and a third phase PC. The third phase PC can be also referred to as residual phase PC. This will be explained below in more detail.

A frequency of the power supply, e.g. a grid frequency, can be 16.7 Hz, 50 Hz or 60 Hz, for example.

For each of the phases PA, PB, PC of the power supply 80, the power input 2 comprises an individual phase input 2A, 2B, 2C. Referring to the one of the phases PA, PB, PC is hence-in view of the construction of the rectifier 1—somehow equivalent to referring to the corresponding phase input 2A, 2B, 2C.

In normal operation, the rectifier 1 rectifies the alternating current (with three phases) provided by the power supply 80 to a direct current (DC).

For this, the rectifier 1 comprises an active front end 10 (AFE 10). The AFE 10 includes a direct current bus 11 (DC bus 11) with two bus lines 12U, 12L. The rectifier 1 has an DC output 14, to which the DC bus 11 is connected. FIG. 1 shows an individual bus line output 15, 16 for each of the bus lines 12U, 12L. For the sake of example, the upper bus line 12U could be a positive bus line and the lower bus line 12L could be a negative bus line.

The AFE 10 is connected to the power input 2 via an LCL filter 30, an interruption unit 40, and an optional RFI filter 60.

In more detail, an input 13 of the AFE 10 is connected to the first phase input 2A along a first connection pathway 4A, to the second phase input 2B along a second connection pathway 4B, and to the third phase input 3B along a third connection pathway 4C. Naturally, the connection pathways 4A to 4C extend through the LCL filter 30, the interruption unit 40, and the RFI filter 60.

In this example, the AFE 10 has two levels.

The bus line 12U is connected to the input 13 of the AFE 10 via a switch arrangement 16 with a plurality of semiconductor switches 17A to 17C. In this example, the bus line 12U is connected with each of the connection pathways 4A to 4C with exactly one corresponding semiconductor switch 17A, 17B, 17C, respectively.

Similarly, the other bus line 12L is connected to the input 13 of the AFE 10 via a switch arrangement 19 with a plurality of semiconductor switches 20A to 20C. In this example, the bus line 12L is connected with each of the connection pathways 4A to 4C with exactly one corresponding semiconductor switch 20A, 20B, 20C, respectively.

In FIG. 1, the semiconductor switches 17A to 17, 20A to 20C are shown as metal-oxide-semiconductor field-effect transistors (MOSFETs). For example, they can be Silicon-Carbide MOSFETs (SiC MOSFETs). Additionally or alternatively, other types and/or numbers of semiconductor switches could be used.

Each of the semiconductor switches 17A to 17C, 20A to 20C is provided with a corresponding free-wheeling rectifier 18A to 18C, 21A to 21C that is connected in parallel with the respective semiconductor switch 17A to 17A, 20A to 20C. The safety rectifiers 18A to 18C, 21A to 21C can be discrete parts (as shown) and/or be integrated in the corresponding semiconductor switches 17A to 17A, 20A to 20C.

Furthermore, an arrangement of altogether six further semiconductor switch 25 is connected between the input 13 of the AFE 10 and a common mode point CMP. In this example, these semiconductor switches 25 are implemented as insulated-gate bipolar transistors (IGBTs), respectively. Each of the connection pathways 4A to 4C is connected to the common mode point CMP by an individual serial pair 24A to 24C of IGBTs 25 with antiparallelly arranged circuit closing rectifiers 26. Hence, there are three of this pairs 24A to 24C.

Naturally, in modifications that are not shown, the AFE 10 can have more than three levels.

The number and arrangement of the semiconductor switches 17A to 17C, 20A to 20C and the corresponding safety rectifiers 18A to 18C, 21A to 21C can vary depending on the power requirements, the number of phases, and the number of levels of the AFE 10. Similarly, the number and arrangement of the IGBTs 25 with the associated security rectifiers 26 can vary.

The bus lines 12U, 12L are coupled via smoothing capacitors 22, 23. The smoothing capacitors 22, 23 have comparatively large capacities. For example, a capacity of the capacitor 22 can be at least 1 mF, maybe at least 2 mF. Additionally or alternatively, a capacity of the capacitor 23 can be at least 1 mF, maybe at least 2 mF. The capacities of the capacitors 22, 23 can be (at least substantially) the same.

The capacitors 22, 23 are arranged in series along an electrical coupling connection coupling the bus lines 12U, 12L. Optionally, the common mode point CMP can be connected to the electrical coupling connection, especially in-between the capacitors 22, 23 as shown in FIG. 1.

The input 13 of the AFE 10 is connected with the power input 2 via the LCL filter 30. In other words, the LCL filter 30 is functionally interposed between the AFE 10 and the power input 2.

The LCL filter 30 includes, respectively for each of the phases PA, PB, PC, a first inductivity 31A, 31B, 31C and a second inductivity 32A, 32B, 32C arranged in series. In more detail, the LCL filter 30 includes, respectively in each of the connection pathways 4A, 4B, 4C, the corresponding first inductivity 31A, 31B, 31C and the corresponding second inductivity 32A, 32B, 32C in series.

The LCL filter 30 includes a capacitor coupling assembly 33 that electrically couples the connection pathways 4A, 4B, 4C. The capacitor coupling assembly 33 is connected to the each of the connection pathways 4A, 4B, 4C between the corresponding first inductivity 31A, 31B, 31C and the corresponding second inductivity 32A, 32B, 32C, respectively

More specifically, in between its first inductivity 31A, 31B, 31C and its second inductivity 32A, 32B, 32C, each of the connection pathways 4A, 4B, 4C is coupled to a common mode point CMPF of the LCL filter 30 via at least one capacitor 34A, 34B, 34C, 36A, 36B, 36C. In the exemplary embodiment, each of those connections has a primary branch with a primary capacitor 34A, 34B, 34C and a parallel secondary branch with a secondary capacitor 36A, 36B, 36C that is arranged in series with an ohmic resistance 35A, 35B, 35C. The capacities of the primary capacitors 34A, 34B, 34C can be identical. The capacities of the secondary capacitors 36A, 36B, 36C can be the identical and/or less than the capacities of the primary capacitors 34A, 34B, 34C. The ohmic resistances 35A, 35B, 35C can be the same.

Further, the common mode point CMPF of the LCL filter 30 can be optionally connected with the common mode point CMP of the AFE 10 and/or connected to the coupling connection, especially in-between the capacitors 22, 23 as shown in FIG. 1.

Further, the LCL filter 30 (and hence the AFE 10) are connected to the power supply 2 via the interruption unit 40. The interruption unit 40 comprises interruption device 41A, 41A for at least N-1 phases, in this case for at least two of the three phases PA, PB, PC. In other words, in the interruption unit 40, in the connection pathways 4A, 4B, 4C for at least N-1 phases, a corresponding interruption device 41A, 41B is implemented. In FIG. 1, the interruption unit 40 includes a first interruption device 41A in the first connection pathway 4A for the first phase PA and a second interruption device 42B in the second connection pathway 4B for the second phase 4B. In the connection pathway 4C for the third phase PC, no interruption device is needed. The third phase PC hence can be referred to as the residual phase PC. The LCL filter 30 (and hence the AFE 10) are always electrically connected with the power supply 2 for the residual phase PC, hence with the third phase input 2C (residual phase input C).

The interruption devices 41A, 41B can be electric relays as in the shown embodiment.

A controller 70 is connected to the interruption unit 40, in particular to all interruption devices 41A, 41B and controls the operation of the interruption devices 41A, 41B.

The controller 70 is able to switch the interruption unit 40 to an interrupting state in which the interruption devices 41A, 41B (e.g. relays) interrupt all connection pathways 4A, 4B except for the connection pathway 4C of the residual phase PC.

For allowing normal operation of the rectifier, the controller 70 can switch the interruption unit 40 to a connecting state in which all interruption devices 41A, 41B (and 41C if present, see FIG. 6) are closed (conductive).

The interruption unit 40 is connected to the power supply 2, maybe via the optional RFI filter 60. The RFI filter can include a ground capacitive coupling arrangement 61 for coupling the connection pathways 4A, 4B, 4C capacitively to a ground reference GND and a first capacitive coupling arrangement 62 for coupling the connection pathways 4A, 4B, 4C capacitively with each other. It can include an inductive coupling arrangement 63 that includes a respective inductivity 63A, 63B, 63C in each of the connection pathways 4A, 4B, 4C and/or is adapted for providing inductive coupling between the connection pathways 4A, 4B, 4C. It can have a second capacitive coupling arrangement 64 for coupling the connection pathways 4A, 4B, 4C capacitively with each other. The inductive coupling arrangement 63 can be arranged in-between the first capacitive coupling arrangement 62 and the second capacitive coupling arrangement 64.

The rectifier 1 includes an inrush protection bypass 50. The inrush protection bypass 50 bypasses the interruption unit 40 for one or more of the non-residual phases 4A, 4B. The non-residual phases 4A, 4B are all phases that are not the residual phase 4C.

The inrush protection bypass 50 includes a half-wave rectification functionality in one and the same direction for all currents (so-called pre-charging currents) that are bypassed past the interruption unit 40.

In the embodiment shown in FIG. 1, the inrush protection bypass 50 bypasses the interruption unit 40 only for the first phase PA. In other words, it bypasses only the first interruption device 41A in the first connection pathway 4A.

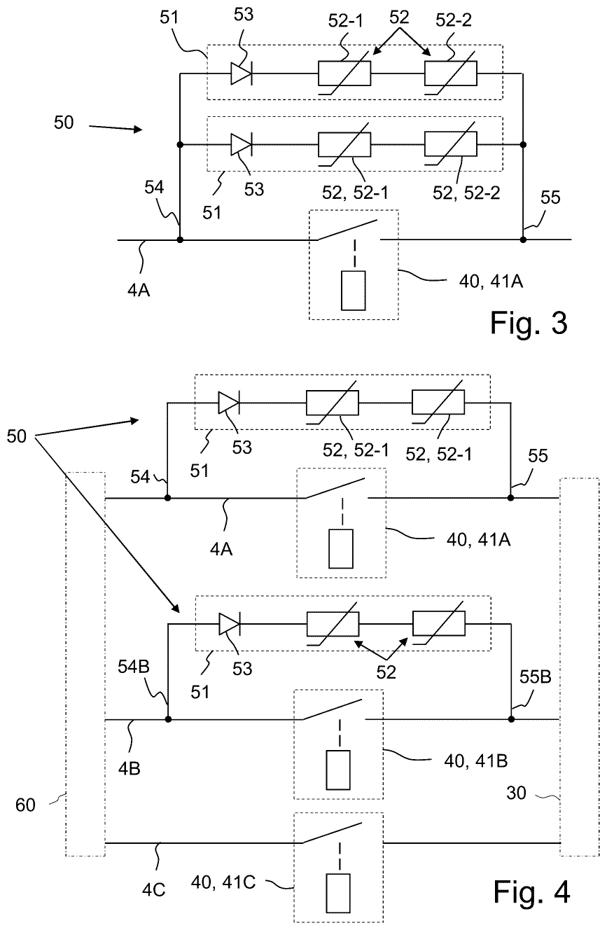

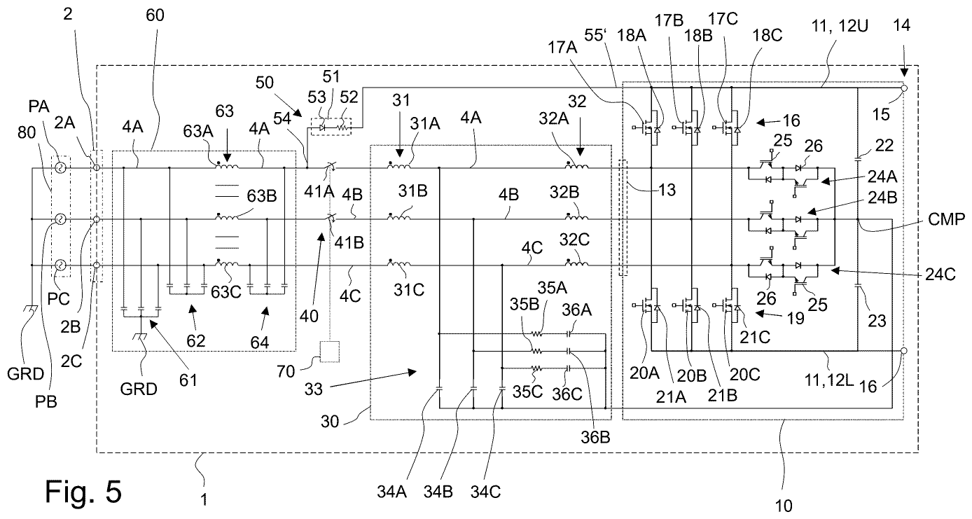

In FIG. 1, the inrush protection bypass 50 includes one bypass branch 51 for the first phase PA (for the first connection pathway 4A, in particular for the first interruption device 41). The bypass branch 51 includes a resistor means 52 and a unidirectionality means 53 that are arranged in series. The unidirectionality means 53 can include or consist of a diode, as shown. The resistor means 52 can include a one or more resistors. Especially, the resistor means 52 can include at least one positive thermal coefficient resistor (PTC) resistor. The resistor symbol at the reference sign 52 in FIG. 1 may be interpreted accordingly. PTC resistors 51-1, 51-2 are explicitly shown in FIGS. 4 and 5.

The inrush protection bypass 50 is conductive only for current flow in one specific direction (from left to right in FIGS. 1, 4 and 5).

A supply-side end 54 of the inrush protection bypass 50 is connected (electrically attached) between the interruption unit 40 and the RFI filter 60. In more detail, the bypass branch 51 for the first phase PA is connected to the first connection pathway 41A for the first phase PA between the interruption unit 40 and the RFI filter 60.

A front-end side 55 of the inrush protection bypass 50 is connected (electrically attached) between the interruption unit 40 and the LCL filter 30. In more detail, the bypass branch 51 for the first phase PA is connected to the first connection pathway 41A for the first phase PA between the interruption unit 40 and the LCL filter 30. In this embodiment, the inrush protection bypass 50 bypasses only the interruption unit 40 and only for the first phase PA.

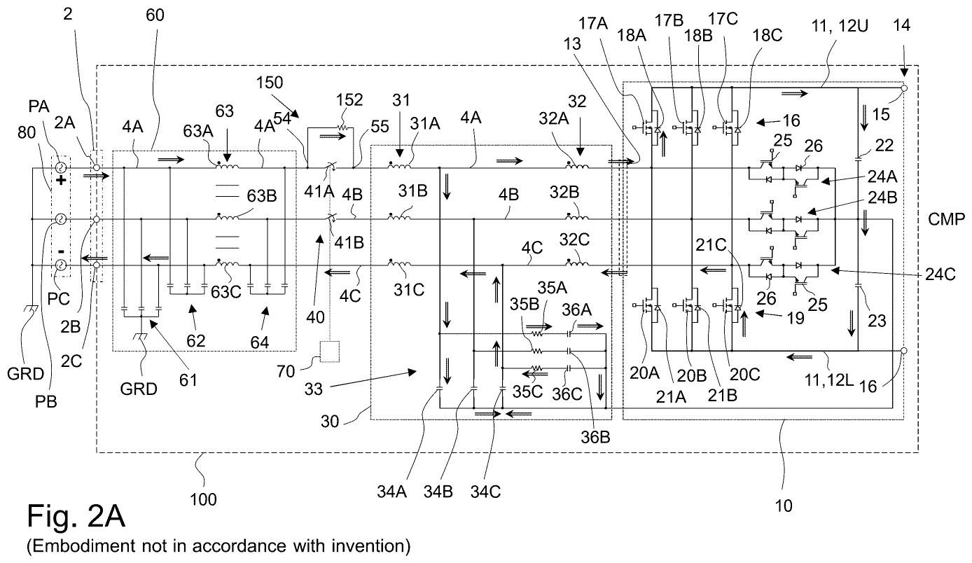

For explaining the effects, in the following it is referred to the hypothetical modified rectifier 100 that is shown in FIGS. 2A and 2B. Elements with the same reference sign are the same and are not discussed again. The modified rectifier 100 differs from the rectifier 1 in that its inrush protection bypass 150 is without the unidirectionality means 53. Different from the inrush protection bypass 50 of the rectifier 1, the inrush protection bypass 150 of the rectifier 100 has no half-wave rectification functionality. Further, the resistor means 152 consist of a simple ohmic resistor.

Starting with FIG. 2A, it is assumed that the rectifier 1 has not been operated and that the power input 2 has just been connected with the power supply 80 (and/or that the power supply 80 was being switch off and has just been turned on). The smoothing capacitors 22, 23 in the AFE are empty (not charged). Similarly, the capacitors 34A, 34B, 34C, 36A, 36B, 36C in the LCL filter 30 are empty. it is assumed that the interruption unit 40 is in its interrupting state. The interruption devices 41A, 41B in the first connection pathway 4A and the second connection pathway 4B are opened. The interruption unit 40 hence interrupts the electrical connection of the LCL filter 30 (and hence of the AFE 10) with the power input 2 via the connection pathways 4A, 4B, 4C for all phases PA, PB except for the single residual phase 4C. Accordingly, no closed circuit can be formed via the connection pathways 4A, 4B, 4C. This avoids that excessive inrush currents flow through the various phases PA, PB, PC in order to charge the comparatively large smoothing capacitors 22, 23.

In order to allow for more controlled pre-charging of the smoothing capacitors 22, 23 with less excessive inrush current, the inrush protection bypass 150 is employed. It bypasses the first phase around the first interruption device 41A for the first phase. The second connection pathway 4B for the second phase PB is interrupted as well (by means of the second interruption device 41B being opened) and since the inrush protection bypass 150 cannot bypass the interruption unit 40 for the second phase PB in this embodiment. There cannot be a second pre-charging current that flows between the second phase PB and the residual phase PC. There is only a first pre-charging current that flows between the first phase PA and the residual phase PC via the inrush protection bypass 150 for pre-charging the smoothing capacitors 22, 23 in this case.

FIGS. 2A and 2B relate to a first stage of a starting sequence for the rectifier 150, in which the interruption unit 40 is in the interrupting state and in which at least the smoothing capacitors 22, 23 are pre-charged via said first pre-charging current.

In FIG. 2A shows the situation during a positive half-wave of the first pre-charging current. The first pre-charging current is indicated by arrows.

The first pre-charging current enters from the first phase PA of the power supply 80 to the power input 2 (in particular to the first phase input 2A). It passes along the first connection pathway 4A through the RFI filter 30. Since the interruption device 41A is open, the first pre-charging current cannot flow through the interruption unit 40 via the first connection pathway 41A.

At the supply-side end 54 of the inrush protection bypass 150, the first pre-charging current enters the inrush protection bypass 150. It flows along a specific direction through the inrush protection bypass 150 and the ohmic resistor 152. The ohmic resistor 152 limits the first pre-charging current, which is the complete inrush current in this embodiment. At the front-end side 55, the first pre-charging current leaves the inrush protection bypass 150 and flows back into the first connection pathway 4A.

The first pre-charging current then passes via the first connection pathway 4A through the LCL filter 30 and to the input 13 of the AFE.

In the first stage of the start-up sequence, the semiconductor switches 17A, 17B, 17C, 20A, 20B, 20C, 25 are not operated. They are non-conductive. No current flows through the semiconductor switches 17A, 17B, 17C, 20A, 20B, 20C, 25 in the first stage of the start-up sequence.

Accordingly, the first pre-charging current flows from the first connection pathways 4A through the safety rectifier 18A to the upper bus line 12U. It then reaches the coupling connection that electrically couples the bus lines 12U, 12L and contributes to pre-charging the capacitor 22. Since the capacitor 22 has still no or only few electric charge, the first pre-charging current is forwarded along the coupling connection and also contributes to pre-charging the capacitor 23, which also has still or only few electric charge.

Then, the first pre-charging current enters the lower bus line 12L and flows through the safety rectifier 21C into the third connection pathway 4C for the residual phase 4C. It flows along the third connection pathway 4C through the LCL filter 30, the interruption unit 40, and the optional RFI filter 60 to the power input 2, namely to the third phase input 2C. From there, it flows to the third phase PC of the power supply 80. As noted above, the interruption unit 40 does not interrupt exactly one of the connection pathway 4C in the interrupting state, in this case the one of the third phase PC, which can therefore be referred to as the residual phase PC.

In FIG. 2B shows the situation during a negative half-wave of the first pre-charging current. The first pre-charging current is indicated by arrows again. In general, the first pre-charging current flow along the same way as in FIG. 2A but in the opposite direction. The only difference in the way is that it passes from the third pathway connection 4C (for the residual phase PC) through the security rectifier 18C to the upper bus line 12U. It then travels through the coupling connection in the same direction as in FIG. 2A, thereby further pre-charging the capacitors 22, 23 in the same manner. The first pre-charging current then flows further via the lower bus line 12L and the security rectifier 21A into the first connection pathway 4A and passes the LCL filter 30.

At the front-end-side end of the inrush protection bypass 150, the (negative half-wave) first pre-charging current enters the inrush protection bypass 150 and flows through it along the opposite direction compared to the specific direction in FIG. 2A. Thereby, it flows through the resistor means 152.

At the supply-side end of the inrush protection bypass 150, the pre-charging current flows back into the first connection pathway 4A and passes the RFI filter 60 to reach the power supply 2, namely the first phase input 2A. From there, it flows to the first phase PA of the power supply 80.

In the embodiment shown in FIGS. 2A and 2B, the first pre-charging current flows through the inrush protection bypass 150 both in the specific direction (during the positive half-waves of the first pre-charging current, see FIG. 2A) and in the opposite direction (during the negative half-waves of the first pre-charging current, see FIG. 2A). Hence, the resistor means 152 is subjected to substantial current flow both during the positive half-waves and the negative half-waves of the pre-charging current. There is a risk that the resistor means 152 can heat up and become damaged. The rectifier 100 could fail. In the worst case, a fire may start.

The first pre-charging current is here substantially limited only by the resistor means 152. The resistor means 152 must have a decent ohmic resistance in order to protect other elements of the rectifier 1 from being damaged by an excessive first pre-charging current.

There is a further problem. In the AFE 10, the safety rectifiers 18A, 18C, 20A, 20C provide full-wave rectification for the first pre-charging current with respect to the DC bus 11 and for pre-charging the capacitors 22, 23. However, there is no such rectification for the capacitors in the LCL filter 30. When comparing FIGS. 2A and 2B, it is evident that especially the capacitors 34A, 34C, 36A, 36C in are subjected to full alternating current between the first phase PA and the residual phase PC in the first stage of the start-up sequence. The capacitors 34A, 34C, 36A, 36C are ongoingly charged in alternating directions. The corresponding current amounts have to flow through the inrush protection bypass 150. This additionally imposes unnecessary stress on the inrush protection bypass 150 including the resistor means 152.

Turning back to FIG. 1, the unidirectionality means 53 provide the half-wave rectification functionality of the inrush protection bypass 50. In the first stage of the start-up sequence, the first pre-charging current will flow like in FIG. 2A during the positive half-waves. However, during its negative half-waves, the first pre-charging current is prevented from flowing by the unidirectionality means 23. Therefore, in total (over a full wave period), the first pre-charging current is effectively halved. Compared to the hypothetical embodiment shown in FIGS. 2A and 2B, less stress is imposed by the first pre-charging current on the resistor means 52 and all other elements that are passed by the first pre-charging current (to be precise excluding the security rectifiers 18A and 20C, which are in FIG. 2B anyway not passed by the first pre-charging current during the negative half-waves).

The pre-charging of the capacitors 22, 23 may take longer in the embodiment of FIG. 1 because only the positive half-waves of the first pre-charging current are used for pre-charging the capacitors 22, 23. However, the components of the rectifier 1 including the inrush protection bypass 50 itself are better protected against the pre-charging current becoming excessive (in total over one or more full phase cycles).

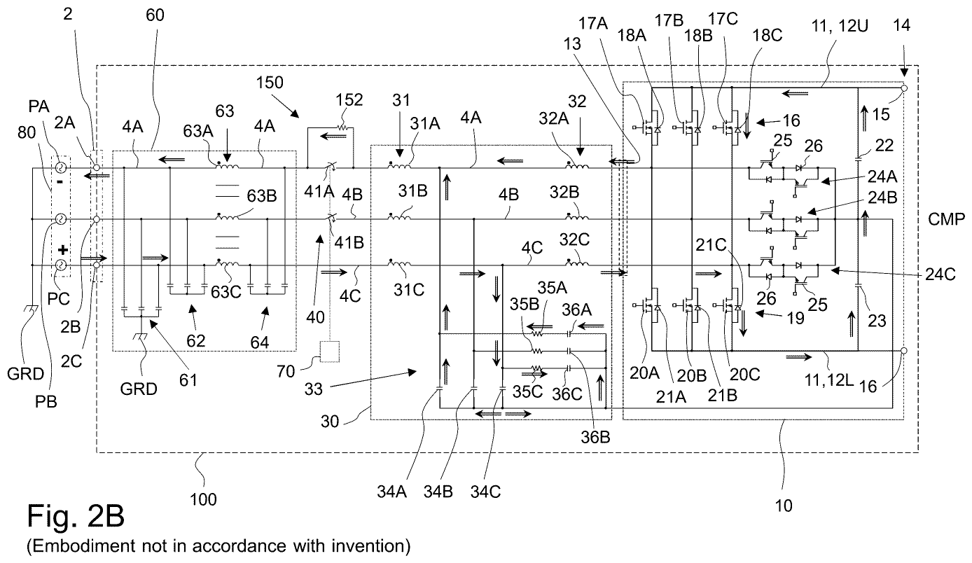

FIG. 3 shows a modification of the inrush protection bypass 50 of the rectifier 1 shown in FIG. 1. The inrush protection bypass 50 in FIG. 3 includes two identical bypass branches 51 for the first phase PA that are connected in parallel. Each of the bypass branches 51 has its individual resistor means 52 and its unidirectionality means 53, arranged in series within the respective bypass branch 51. In this modification, the resistor means 52 consist of two PTC resistors 52-1, 52-2 that are connected in series, respectively. Each of the PTC resistors 52-1, 52-2 can have a rated resistance of at least 10 Ohm, maybe of at least 30 Ohm. They can have a rated resistance of 2000 Ohm at the maximum, maybe of 300 Ohm at the maximum. The rated resistance may be defined at a temperature value in the range from 10° to 30°, for example, maybe at 20 C. In general, the choice of the PTC resistance value(s) is by nature strongly dependent on the design of the circuit and the conditions to be expected.

In this modification, the inrush protection bypass 50 bypasses only the interruption unit 40 and only for the first phase PA. In other words, it bypasses only the first connection pathway 4A and only around the interruption unit 40.

With this approach, the first pre-charging current can be distributed on the two bypass branches 51. Only half of the first pre-charging current flows through the individual branches 51, respectively. Hence, only half of the first pre-charging current flows through the individual resistor means 52 and the individual unidirectionality means 53. This reduces the stress on these components.

FIG. 4 shows a further modification of the inrush protection bypass 50 of the rectifier 1 shown in FIG. 1. The inrush protection bypass 50 in FIG. 4 includes two identical bypass branches 51. One of the bypass branches 51 is for the first phase PA. It bypasses only the first connection pathway 4A and only around the interruption unit 40. The other one of the bypass branches 51 is for the second phase PB. It bypasses only the second connection pathway 4B and only around the interruption unit 40.

A supply-side end 54A of the bypass branch 51 for the second phase PB is electrically connected to the second connection pathway 41B between the interruption unit 40 and the RFI filter 60. A front-side end 55B the bypass branch 51 for the second phase PB is electrically connected to the second connection pathway 4B between the interruption unit 40 and the LCL filter 30.

In this modification, the inrush protection bypass 50 bypasses also only the interruption unit 40 but for the first phase PA and the second phase PB.

Due to the additional bypass branch 51 for the second phase 4B, a second pre-charging current flowing between the second phase PB and the residual phase PC is used. The half-wave rectification functionality is in the same direction for all bypass branches 51. The second pre-charging current will flow actually only during its positive half-waves and will be blocked by the inrush protection bypass 50 during its negative half-waves.

This is an approach to distribute the pre-charging currents to two non-residual phases PA, PB. In the AFE 10, the security rectifiers 18B is used for passing the second pre-charging current (during the non-blocked positive halve-waves thereof) to the upper bus line 12U. This means that the security rectifier 18A does not bear all pre-charging currents like in FIG. 1.

Naturally, the residual phase PC has to bear both the first pre-charging current coming from phase A and the second pre-charging current coming from phase B.

Starting from FIG. 4, there can be two or more bypass branches 51 (as in FIG. 3) for each of the phases PA, PB, respectively. This further reduces the current portions flowing through the individual bypass branches 51 and thus through the individual resistor means 52 and the individual unidirectionality means 53.

If an optional interruption device 41C in the connection pathway 4C for the third phase PC is present as well (see FIG. 4), in the interrupting state, only one of the interruption devices 41A, 41B, 41C is closed and all other ones are opened. The closed one must be one that is not bypassed by any inrush protection bypass having half-wave rectification functionality in the same specific direction. The corresponding phase PC is the residual phase.

The additional interruption device 41C is in general not necessary. However, it can be added for implementing a disconnecting state, in which all connection pathways 4A, 4B, 4C are interrupted such that the LCL filter 30 and the AFE 10 are fully disconnected. Even with the modification of the inrush protection bypass 50 shown in FIG. 4, no current can flow between the power input 2 and the AFE 10 because the bypass branches 51 for both the first phase PA and PB have the half-wave rectification functionality in the same specific direction. No current can flow between the first phase PA and the second phase PB when the interruption devices 41A, 41B are open. This is a further advantage.

In a further modification (not shown), the additional interruption device 41C for the residual phase PC is present and there is at least one special bypass branch for bypassing the interruption device 41C for the residual phase PC. In this case, pre-charging current(s) can flow even when all interruption devices 41A, 41B, 41C are open. This special bypass branch(es) for the residual phase PC may be referred to as residual bypass branch(es). As an example, starting from FIG. 4, a residual bypass branch could bypass the third connection pathway 4C for only the third interruption device 41C. Since the bypass branch(es) for all other phases PA, PB have unidirectionality means 53, there is no need to include unidirectionality means in the residual bypass branch(es). For example, the residual bypass branch(es) could be formed like the bypass branch 150 in FIG. 1. Of course, each residual bypass branch can include at least one ohmic resistor and/or at least one PTC resistor. If there are unidirectionality means in the residual bypass branch(es), the residual bypass branch(es) may be conductive for current flow in the opposite direction only (i.e. in the opposite direction compared to all bypass branches 51 for the non-residual phases PA, PB).

FIG. 5 shows a further modification of the rectifier 1. In this case, the inrush protection bypass 50 does not only bypass the interruption unit 40 for the first phase PA but also the LCL filter 30. The front-end-side 55′ of the inrush protection bypass 50 is in this case connected to the upper bus line 12U. The inrush protection bypass 50 could also include two or more parallel branches like in FIG. 3. It could also include bypass branches 51 for both non-residual phases PA, PB like in FIG. 4, wherein the front-end-side ends 55, 55B of the bypass branches 51 in FIG. 4 would be connected in parallel with the upper bus line 12U.

After the smoothing capacitors 22, 23 are sufficiently pre-charged, the first stage of the start-up sequence ends. In a second stage of the start-up sequence, the controller 70 ensures that all interruption devices 41A, 41B, 41C are closed. In particular, it closes the interruption devices 41A, 41B. The interruption device 41C (if present) was already closed in the first stage.

Then, the rectifier 1 can start with normal operation.

While the present disclosure has been illustrated and described and with respect to a particular embodiment thereof, it should be appreciated by those of ordinary skill in the art that various modifications to this disclosure may be made without departing from the spirit and scope of the present disclosure.

What is claimed is:

1. A rectifier for rectifying alternating current from a power source with N phases wherein N is at least two, wherein the rectifier comprises:
a power input for connection with the power source;
an LCL filter connected to the power input via an interruption unit;
an active front end with at least two levels, wherein the active front end includes a direct current bus with bus lines and is connected to the power input via the LCL filter and the interruption unit;
the interruption unit, wherein the interruption unit is switchable to an interrupting state in which the interruption unit disconnects the LCL filter and hence the active front end from the power input for N-1 phases of the N phases, said N-1 phases including a first phase; and
an inrush protection bypass for bypassing the interruption unit for the first phase, wherein the inrush protection bypass is conductive only for current flow in one specific direction.

2. The rectifier according to claim 1, wherein the inrush protection bypass includes at least one bypass branch with unidirectionality means.

3. The rectifier according to claim 2, wherein the unidirectionality means includes a diode.

4. The rectifier according to claim 2, wherein the at least one bypass branch further includes a resistor means that is arranged in series with the unidirectionality means.

5. The rectifier according to claim 4, wherein the resistor means includes a positive thermal coefficient resistor and/or an ohmic resistor.

6. The rectifier according to claim 1, wherein the bus lines are coupled via smoothing capacitors wherein the rectifier is configured for pre-charging the smoothing capacitors with the inrush protection bypass by a pre-charging current flowing with respect to the first phase when the interruption unit is in the interrupting state, wherein the inrush protection bypass allows only passage of positive half waves or negative half waves for the pre-charging current.

7. The rectifier according to claim 1, wherein the inrush protection bypass includes two bypass branches in parallel.

8. The rectifier according to claim 1, wherein the rectifier further includes a line filter, wherein the line filter is functionally arranged between the power input and the interruption unit.

9. The rectifier according to claim 1, wherein a supply-side end of the inrush protection bypass is connected between the interruption unit and the power input.

10. The rectifier according to claim 1, wherein a front-end-side of the inrush protection bypass is connected between the interruption unit and the LCL filter.

11. The rectifier according to claim 1, wherein a front-end-side of the inrush protection bypass is connected to one of the bus lines.

12. The rectifier according to claim 1, wherein the rectifier comprises a controller for switching the interruption unit between the interrupting state and a connecting state.

13. The rectifier according to claim 1, wherein the interruption unit includes, for each of the N-1 phases respectively at least one interruption device wherein the interruption devices are electric relays.

14. The rectifier according to claim 1, wherein N is at least three, wherein the inrush protection bypass is for bypassing the interruption unit for several of the N-1 phases wherein the inrush protection bypass is conductive for only passing current in the one specific direction for the several of the N-1 phases

15. A method for starting up power supply to a rectifier, wherein the rectifier is for rectifying alternating current from a power source with N phases, wherein N is at least two, and comprises a power input, an LCL filter connected to the power input via an interruption unit, and an active front end with at least two levels, wherein the active front end includes a direct current bus with bus lines and is connected to the power input via the LCL filter and the interruption unit,
wherein the method includes:
providing alternating current from the power source to the power input while the interruption unit is switched to an interrupting state in which the interruption unit disconnects the LCL filter and hence the active front end from the power input for N-1 phases of the N phases said N-1 phases including a first phase;
pre-charging at least smoothing capacitors that couple the bus lines using a first pre-charging current flowing through the first phase, wherein an inrush protection bypass bypasses the first pre-charging current past the interruption for the first phase in the interruption unit and rectifies the first pre-charging current.

16. The method according to claim 15, wherein the method includes switching the interruption unit to a connecting state such that the LCL filter and hence the active front end are connected to the power supply for all N phases for normal operation of the rectifier.
